(19) United States
(12) Patent Application Publication
(10) Pub. No.: US 2015/0356832 A1
(43) Pub. Date: Dec. 10, 2015

(54) SYSTEM AND METHOD FOR CONDUCTING A CASINO STYLE GAME UTILIZING BOTH PLAYING CARDS AND DICE

(71) Applicant: 297 Partners LLC, Oranjestad (AW)

(72) Inventors: Ramon Helgers, Oranjestad (AW); Stanley Nieuwkerk, Oranjestad (AW); Trasis Lozano, Oranjestad (AW)

(21) Appl. No.: 14/298,412

(22) Filed: Jun. 6, 2014

(51) Int. Cl. G07F 17/32; A63F 1/06

(52) U.S. Cl. CPC G07F 17/3293; G07F 17/3244; G07F 17/3225; A63F 1/067

(57) ABSTRACT

A card and dice system and method whereby players seek to discard each of multiple cards in their hand, based on dice roll outcomes, before any opposing player thereby winning a pot. The pot is funded via all or portions of initial antes, various fines or penalties paid by players, based on dice roll outcomes and a comparison of dice roll outcomes to ranks of cards of the players whereby dice roll outcomes matching card ranks require a designated player shooter or neighboring player to discard such cards, and insurance bets. A modified deck of cards is used and includes four suits ( [symbol] , [symbol] , ♡ and ♦) and ranks of 2-6 and 8-Queen (i.e., no 7s, Kings or Aces).

### FIELD OF THE INVENTION

The embodiments of the present invention relate to a casino game system and method involving a modified deck of cards and dice wherein a winning player collects a pot funded by the participating players.

### BACKGROUND

Casino gaming continues to expand throughout the world. The Internet and mobile devices have accelerated the growth of gaming. While there are numerous popular games of chance in the market, it would be beneficial to develop a gaming system and method combining cards and dice which pits players against one another.

Thus, it would be advantageous to develop a modified system and method utilizing card and dice to conduct a game pitting players against one another.

### SUMMARY

The embodiments of the present invention are broadly related to a card and dice method and system whereby players seek to be the first to discard each of multiple cards in their hand, based on dice roll outcomes, thereby winning the pot. The pot is funded via all or portions of initial antes, various fines or penalties paid by players, based on dice rolls and a comparison of dice roll outcomes to ranks of cards of the players whereby dice roll outcomes matching card ranks require a designated player shooter or neighboring player to discard such cards, and insurance bets. A modified deck of cards is used and includes four conventional suits ( [symbol] , [symbol] , ♡ and ♦) and ranks of 2-6 and 8-Queen (i.e., no 7s, Kings or Aces).

In one embodiment, an electronically-implemented method conducted over a network of gaming devices, comprising: utilizing at least a processor, random number generator and memory to facilitate: randomizing one or more decks of simulated playing cards, each of said one or more decks of simulated playing cards having 40 cards comprising ranks of 2-6, 8-10, Jack and Queen of spades, clubs, hearts and diamonds; accepting, via a gaming device interface associated with each gaming device, an ante from each participating player; displaying on a gaming device display associated with each gaming device multiple face-up cards for each player; responsive to an input, via a gaming device interface, by a designated player shooter, generating a random dice roll of a pair of simulated dice; comparing a sum of said random dice roll of said pair of simulated dice to ranks of each of said designated player shooter's multiple face-up cards; based on said comparison: (i) removing one or more cards of said designated player shooter having ranks matching said sum of said random dice roll of said pair of simulated dice or (ii) if said designated player shooter holds no cards with a rank matching said sum of said random dice roll of said pair of simulated dice, comparing said sum of said random dice roll of said pair of simulated dice to ranks of each of multiple face-up cards held by a neighboring player and removing any cards having matching ranks; collecting payment of a fine and paying said fine into a pot from said designated player shooter if neither said designated player shooter or neighboring player holds at least one card having a matching rank of said sum of said random dice roll of said pair of simulated dice; and responsive to a designated player shooter having each of said multiple face-up cards removed, paying said designated player shooter at least a portion of said pot.

In another embodiment, a gaming system, comprises: a gaming table dimensioned to accommodate at least seven players and a dealer; a layout affixed to said gaming table; a chip rack integrated into said gaming table; one or more decks of playing cards, each of said one or more decks of playing cards having 40 cards comprising ranks of 2-6, 8-10, Jack and Queen of spades, clubs, hearts and diamonds; a pair of dice; and a dice rolling area defined by a wall proximate a dealer area.

Other system and method embodiments include optional features such as an insurance bet for players neighboring a designated player shooter holding a single card, roll dice again responsive to certain roll outcomes and jackpots and progressive jackpots for certain card combinations.

In a live embodiment, a gaming table includes a game layout and dice rolling area defined by a wall into which players may roll the game dice. A dealer manages the live version of the game.

The embodiments of the present invention are suitable as live table games and distributed via electronic formats such as a standalone gaming machines, gaming machine networks, smart phones, tablets and computer terminals.

Other variations, embodiments and features of the present invention will become evident from the following detailed description, drawings and claims.

### BRIEF DESCRIPTION OF THE DRAWINGS

FIG. 1 illustrates a block diagram of components of an electronic gaming device for conducting a casino game according to the embodiments of the present invention;

FIG. 2 illustrates a block diagram of a wireless system accessible by mobile devices for conducting a casino game according to the embodiments of the present invention;

FIG. 3 illustrates an exemplary layout according to the embodiments of the present invention;

FIG. 4 illustrates a flow chart detailing one live game methodology of conducting a casino game according to the embodiments of the present invention;

FIG. 5 illustrates a flow chart detailing one electronically-implemented methodology of conducting a casino game according to the embodiments of the present invention;

FIGS. 6a-6f illustrate a round or hand of an exemplary casino game being played according to the embodiments of the present invention; and

FIGS. 7a and 7b illustrate a gaming table suitable to conduct the methods according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming device” and “gaming machine” should be understood to be any one of a general purpose computer, as for example a personal computer or a laptop computer, a client computer configured for interaction with a server, a special purpose computer such as a server, or a smart phone, tablet computer, personal digital assistant or any other machine adapted for executing programmable instructions in accordance with the description thereof set forth herein.

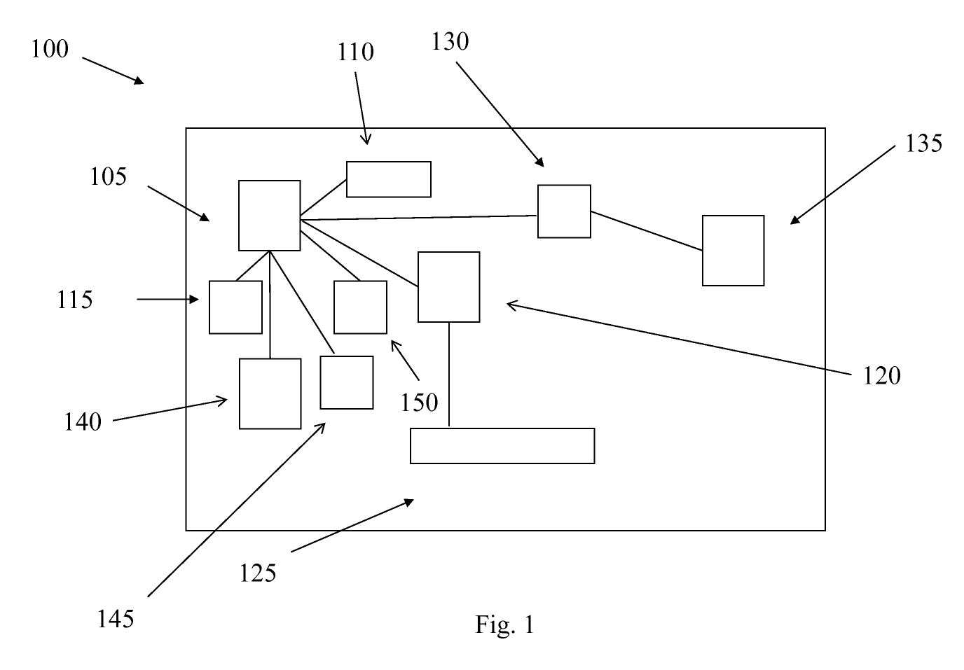

In addition to gaming tables, the embodiments of the present invention may be facilitated by an electronic gaming device whereby multiple players play against one another under the control of a central server as described herein. Besides mobile devices, the electronic gaming device may be a standalone device and bar-top device forming part of a gaming device network or not. A block diagram of the electronic gaming device 100 is shown in FIG. 1. The exemplary electronic gaming device 100 may include a central processing unit (CPU) also deemed a processor 105 which controls the electronic gaming device 100 based on instructions stored in program read-only memory (ROM) 110 and pay table ROM 115. Program ROM 110 stores executable instructions related to the operation of the gaming device 100 and which are generally permanent. CPU 105 may be connected to a video controller 120 which provides output to one or more video displays 125. Similarly, an audio controller 130 provides audio output as dictated by the CPU 105 through speakers 135. The aforementioned components, and others, may be attached to a circuit board forming a motherboard. In another embodiment, the electronic gaming device 100 may be linked to a central game server which allows players to select from a number of games via the electronic gaming device 100. In such an embodiment, one or more processors integrated into the central server control the gaming device 100 based on instructions stored in program ROM 110.

A user interface 140 may respond to buttons on button panel or display incorporating touch screen technology or any other devices providing means for users to communicate with, and instruct, the electronic gaming device 100. Wager memory 145 stores an amount of money/credits deposited into the electronic gaming device 100 by a player and specific wager information related to each play of the electronic gaming device 100. Payout system 150 includes a coupon printer or similar device for receiving money/coupon from the electronic gaming device 100.

Those skilled in the art will recognize that the configuration and features of the electronic gaming device 100 disclosed herein are exemplary and may be altered in any number of ways without impacting the embodiments of the present invention.

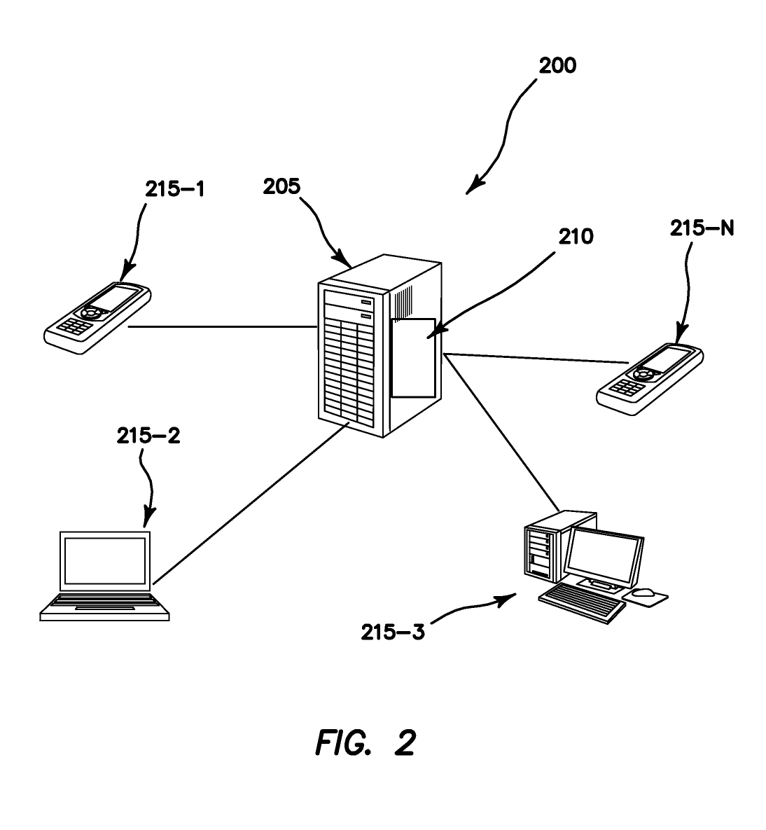

FIG. 2 shows a block diagram of a wireless system 200 which may be used to facilitate remote play of the game according to the embodiments of the present invention. The wireless system 200 comprises a game server 205, including one or more processors 210 running game software, and remote devices 215-1 through 215-N (e.g., smart phones) configured to access said game server 205 facilitating game play on the remote devices 215-1 through 215-N. In another embodiment, the video game according to the embodiments of the present invention may be in the form of a software application (“App”) downloadable onto smart phones, tablets or computers and playable via processing power and a user interface associated therewith. Wired connections may be used as well.

The embodiments of the present invention are directed to a casino game pitting players against one another reminiscent of poker. A pot is funded via antes, fines paid by players as the game progresses and certain conditions are not met (e.g., no match between dice roll outcomes and card ranks of a designated player shooter and neighboring player) and/or insurance bets. A winner is a first player to have no cards remaining in his or her hand. A detailed system and method are disclosed below.

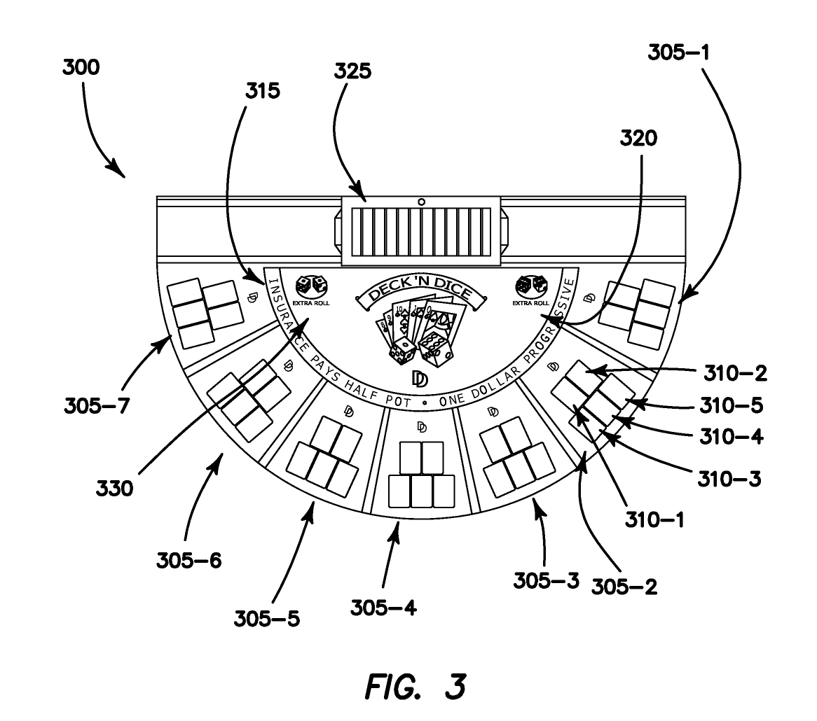

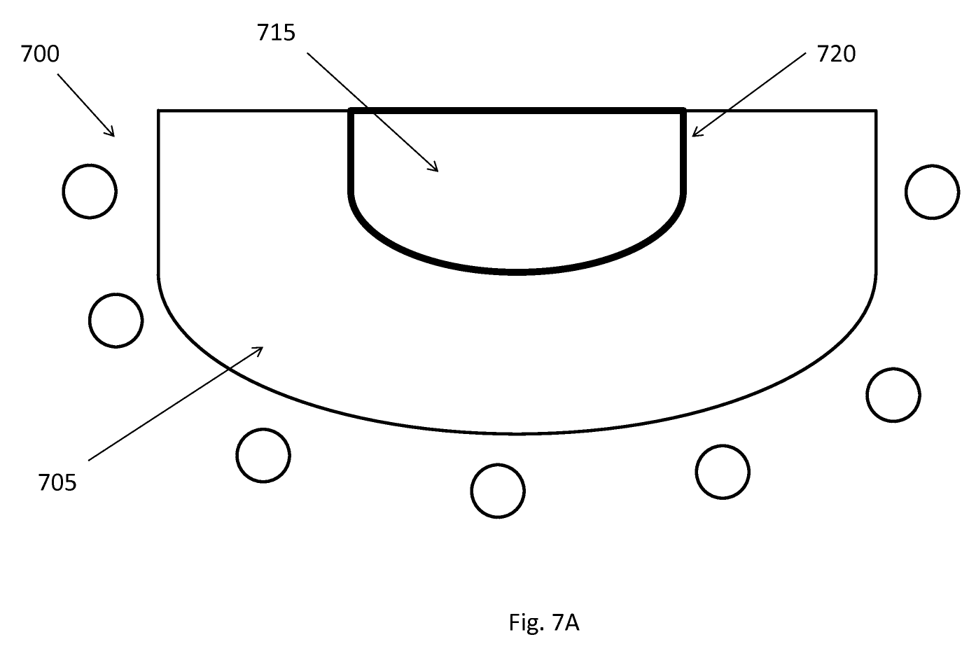

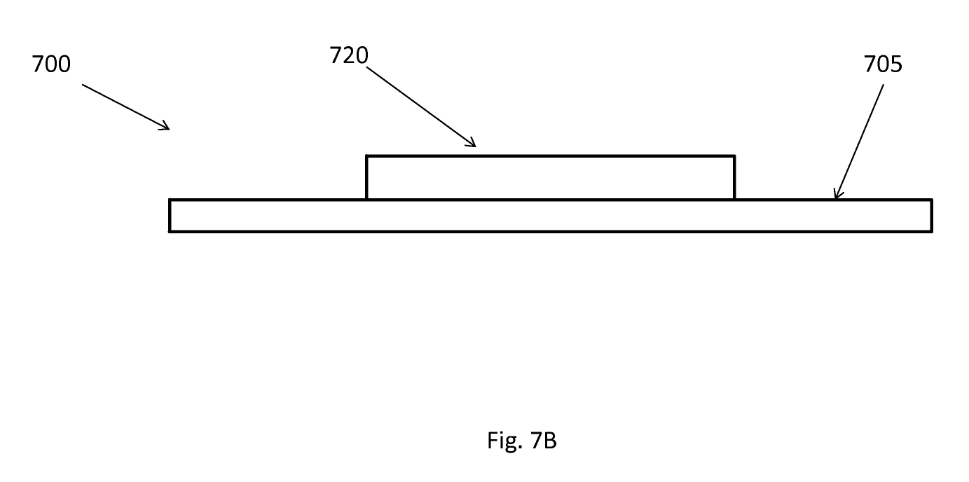

FIG. 3 shows an exemplary layout 300 comprising seven player positions 305-1 through 305-7, each depicting five card positions 310-1 through 310-5, insurance bet and progressive wager area 315 and a dice roll area 320. In a live embodiment, the layout 300 may be secured to a gaming table and include a chip rack 325 as well as a dice roll wall (best seen in FIGS. 7a and 7b) surrounding the dice roll area 320. In one embodiment, the dice roll wall is fabricated of transparent plastic approximately 4 inches tall. Those skilled in the art will recognize that other layouts and dice roll walls are conceivable.

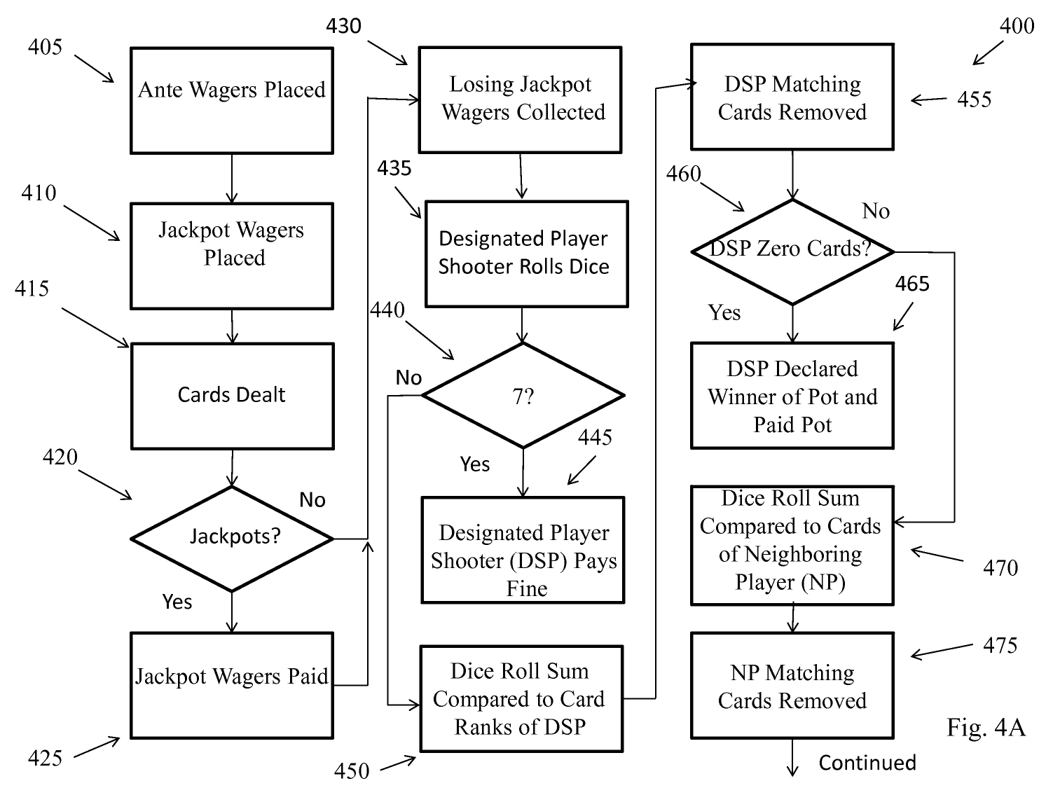

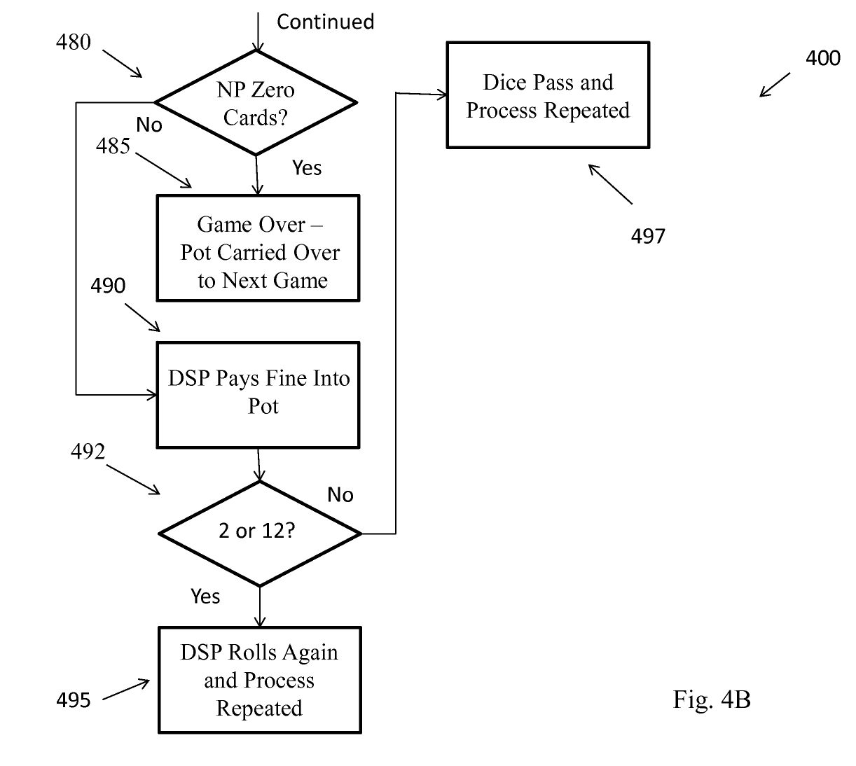

FIG. 4 shows a flow chart 400 detailing a live methodology for conducting a casino game according to the embodiments of the present invention. At 405, players pay antes in an amount established by the casino, house or operator. In one embodiment, the ante is $10. All, none or a portion of the antes may be used to fund a pot while any balance is collected by the operator. At 410, players have the option to place a progressive wager in an amount established by the casino, house or operator. In one embodiment, the progressive wager is $1 which is collected by the operator. In a conventional fashion, a portion of the progressive wager funds a progressive jackpot payable partially or totally responsive to the occurrence of one or more low probability card combinations. While a progressive jackpot is disclosed, fixed payouts may be used as well. At 415, a dealer deals each player five cards face up from the deck of 40 cards (i.e., conventional deck of 52 cards minus 7s, Aces and Kings). The use of a 40-card deck of playing cards generates 658,008 possible 5-card hand outcomes. At 420, the dealer determines if any hand of a player placing the progressive wager comprises a winning 5-card combination for payment of the progressive jackpot or portion thereof. At 425, winning progressive wagers, if any, are paid according to, for example, table 1 set forth below. At 430, losing jackpot wagers are collected. At some point before dice are rolled, a player is designated as an initial shooter. As with blackjack, an initial designated player shooter may be the player to the dealer's farthest left or as with poker the initial designated shooter may change based on the passage of a button. Indeed, the designated may be chosen randomly or using any desired means. Once selected, at 435, the designated player shooter rolls a pair of dice into a dice rolling area establishing a sum of the dice roll. At 440, it is determined if the sum of the dice roll is seven. If so, at 445, the designated player shooter pays a fine (e.g., $10 into the pot) and the dice are passed to a next designated player shooter to the immediate left. If, at 440, the sum of the dice roll is not seven, at 450, the sum of the dice roll is compared to the ranks of the cards of the designated player shooter to determine if the sum of the dice roll matches the rank of any cards held by the designated player shooter. If so, at 455, any cards having ranks equal to the sum of the dice roll are removed from play. At 460, it is determined if the designated player shooter has zero cards and, if so, at 465, the designated shooter player is declared the winner and paid the pot. If, at 450, it is determined that no cards of the designated player shooter have a rank matching the sum of the dice roll, at 470, the ranks of the cards of a player to the immediate left of the designated player shooter are compared to the sum of the dice roll. If any matches occur, at 475, the cards of the neighboring player are removed. At 480, it is determined if the neighboring player has zero cards. If so, at 485, the current game is concluded and a new game begins with the pot carrying over to the new game. If, at 450 and 470, no cards of the designated player shooter or neighboring player match the sum of the dice roll, at 490, the designated player shooter pays a pre-established fine into the pot. At 492, it is determined if the sum of the dice roll is two or twelve. If so, at 495, the designated player shooter rolls again. If not, at 497, the dice are passed to a next designated player shooter and the process is repeated.

TABLE 1

| Hand | Payout |
|---|---|
| 2 [symbol] -3 [symbol] -4 [symbol] -5 [symbol] -6 [symbol] or 8 [symbol] -9 [symbol] -10 [symbol] -J [symbol] -Q [symbol] | 100% of Progressive |
| 2-3-4-5-6 or 8-9-10-J-Q of [symbol] , ♡ or ♦ | A % of Progressive |
| Four of a Kind | B % of Progressive |
| Full House | C % of Progressive |
| Flush | D % of Progressive |

In another embodiment, when a neighboring player to the left of the designated shooter has only a single card, an insurance bet is provided. In practice, when the designated shooter player is passed the two dice and the neighboring player has a single card, the dealer offers the neighboring player the option to place an insurance bet which may be added to the pot or collected by the casino. The insurance bet provides the neighboring player 50% of the pot if the comparison of the sum of rolled dice to the card ranks of the designated player shooter reveals no matches but the card rank of the neighboring player's single card matches the sum of the rolled dice resulting in the card being removed and the neighboring player having zero cards. Thus, in this embodiment, if the neighboring player first pays the insurance bet and on a next roll by a designated player shooter is able to remove the single card, the neighboring player is paid 50% of the pot (rather than 0% of the pot as set forth in flow chart 400) and the game ends with the remaining 50% of the pot carried over to a next game. In one embodiment, the insurance bet is placed once and stays active for the remainder of the game.

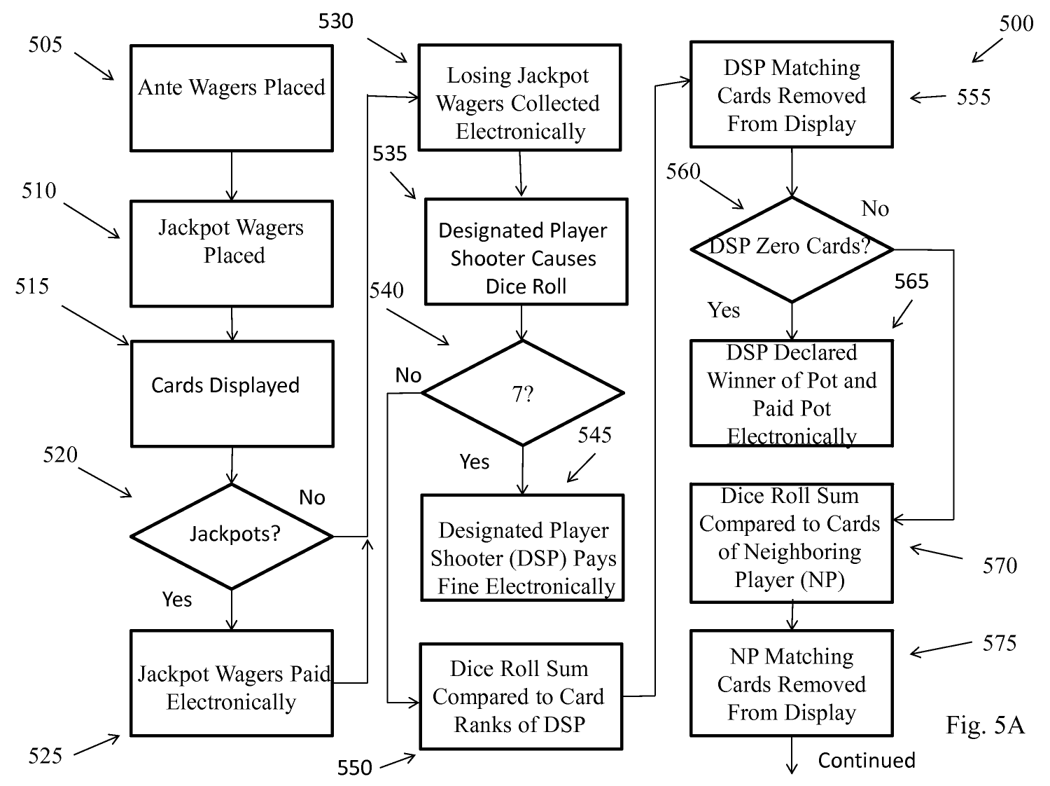

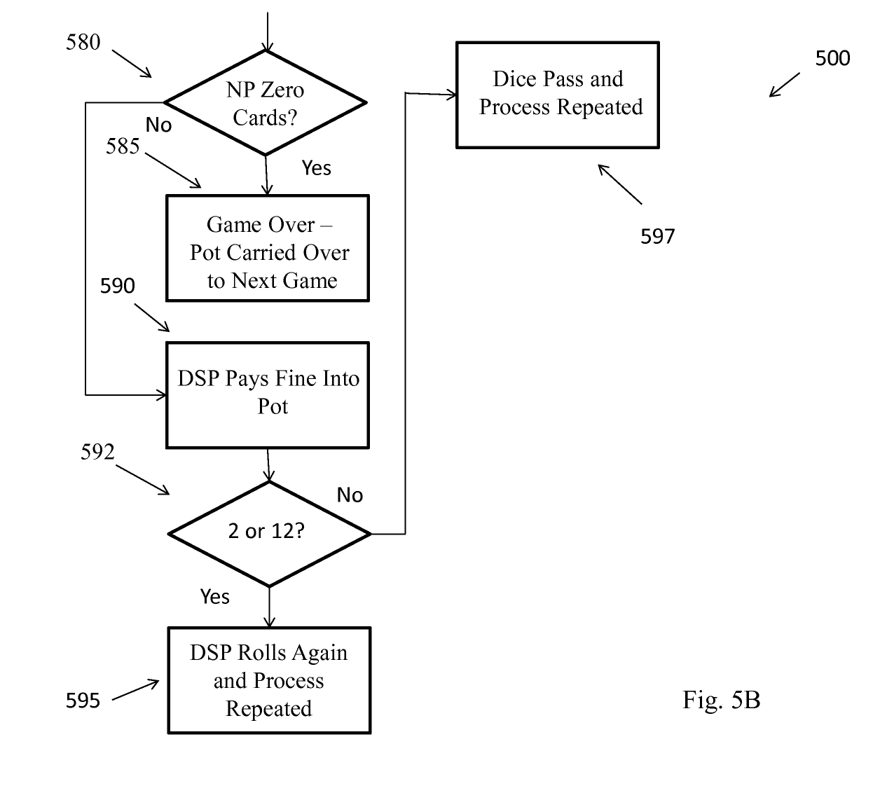

FIG. 5 shows a flow chart 500 detailing an electronic online methodology for conducting a casino game according to the embodiments of the present invention. In this embodiment, a system 200 such as that shown in FIG. 2 facilitates an online embodiment. At 505, players utilize a user interface on each player's gaming device to place antes in an amount established by the casino, house or operator. At 510, players have the option to place a progressive wager via the user interface on each player's gaming device in an amount established by the casino, house or operator. At 515, a central processor causes each player to receive five cards face up from the deck of 40 cards (i.e., conventional deck of 52 cards minus 7s, Aces and Kings) on a display of each player's gaming device. All players can view each of the player's hands on the displays of each player's gaming device. At 520, the central processor determines if any hand of a player placing the progressive wager comprises a winning 5-card combination for payment of the progressive jackpot or portion thereof. At 525, any progressive payouts are made electronically by the processor to a player account. At 530, losing progressive wagers are collected. At some point before the dice are rolled, a player is designated as an initial shooter. Once selected, at 535, the designated player shooter causes a pair of simulated dice to randomly generate an outcome. A software-based random number generator in communication with the processor facilitates the generation of the outcome. At 540, the processor determines if the sum of the dice roll is seven. If so, at 545, the processor collects a fine (e.g., $10 into a pot) from the designated player shooter's account and the player to the left becomes the designated player shooter. If, at 540, the sum of the dice roll is not seven, at 550, the sum of the dice roll is compared by the processor to the cards of the designated player shooter to determine if the sum of the dice roll matches the rank of any cards held by the designated player shooter. If so, at 555, any cards of the designated player shooter having a rank matching the sum of the rolled dice are removed from the displays by the processor. At 560, the processor determines if the designated player shooter has zero cards and, if so, at 565, the designated shooter player is declared the winner and the pot is electronically transferred to the player's account. If, at 555, the processor determines that the designated player shooter has no cards with matching ranks to the sum of the dice roll, at 570, the processor compares the ranks of the cards of a player to the immediate left of the designated player shooter to the sum of the dice roll. If any matches occur, at 575, the processor removes the cards of the neighboring player from the displays. At 580, the processor determines if the neighboring player has zero cards. If so, at 585, the current game is concluded and a new game begins with the pot carrying over to the new game. If no cards of the designated player shooter and neighboring player have a rank matching the sum of the dice roll, at 590, the processor collects a fine from the designated player shooter and places it in the pot. At 592, the processor determines if the sum of the dice roll is two or twelve. If so, at 595, the designated player causes another roll. If not, at 597, the dice are passed to a next designated player shooter and the process is repeated. The insurance bet option is available with the electronic embodiments as well.

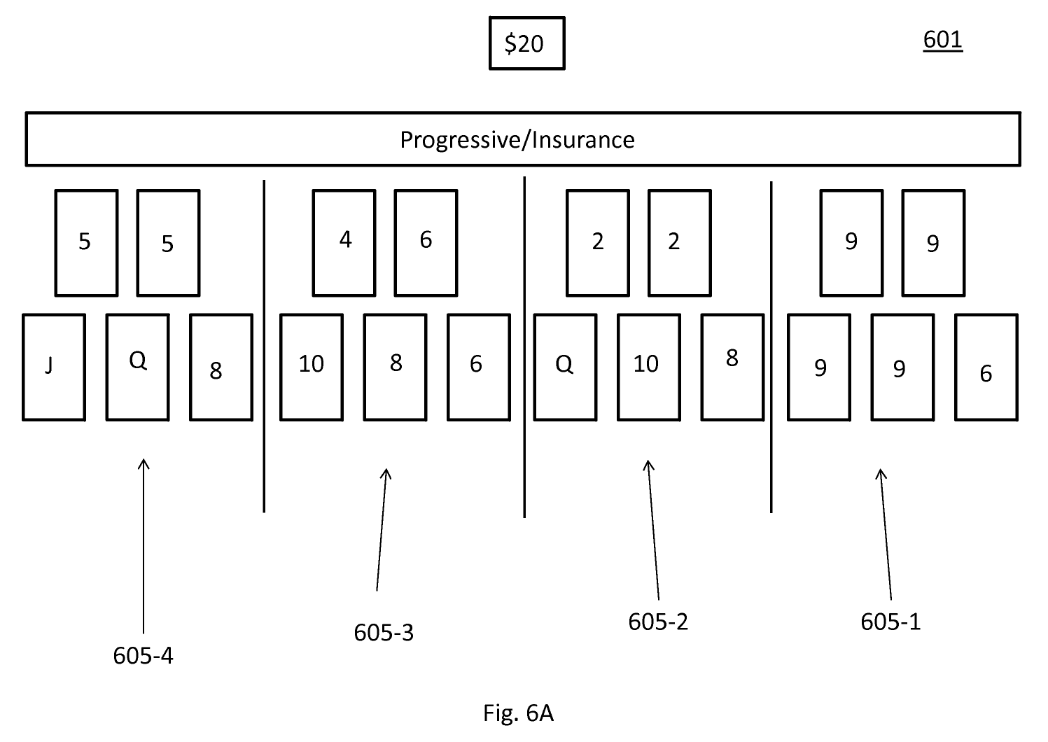

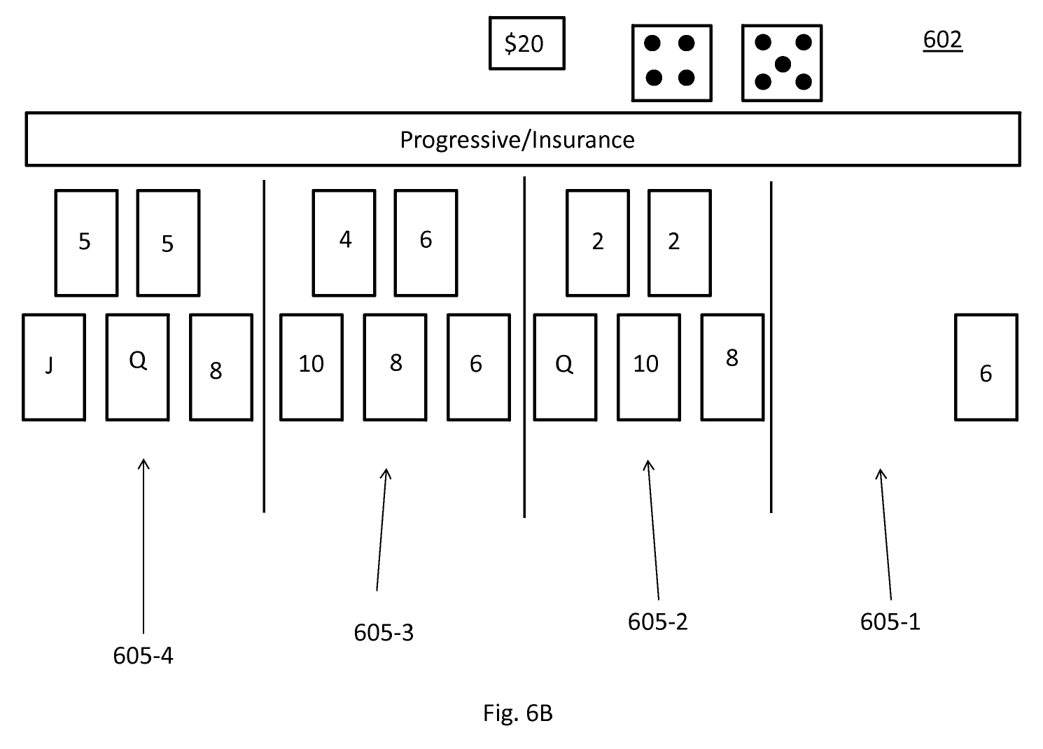

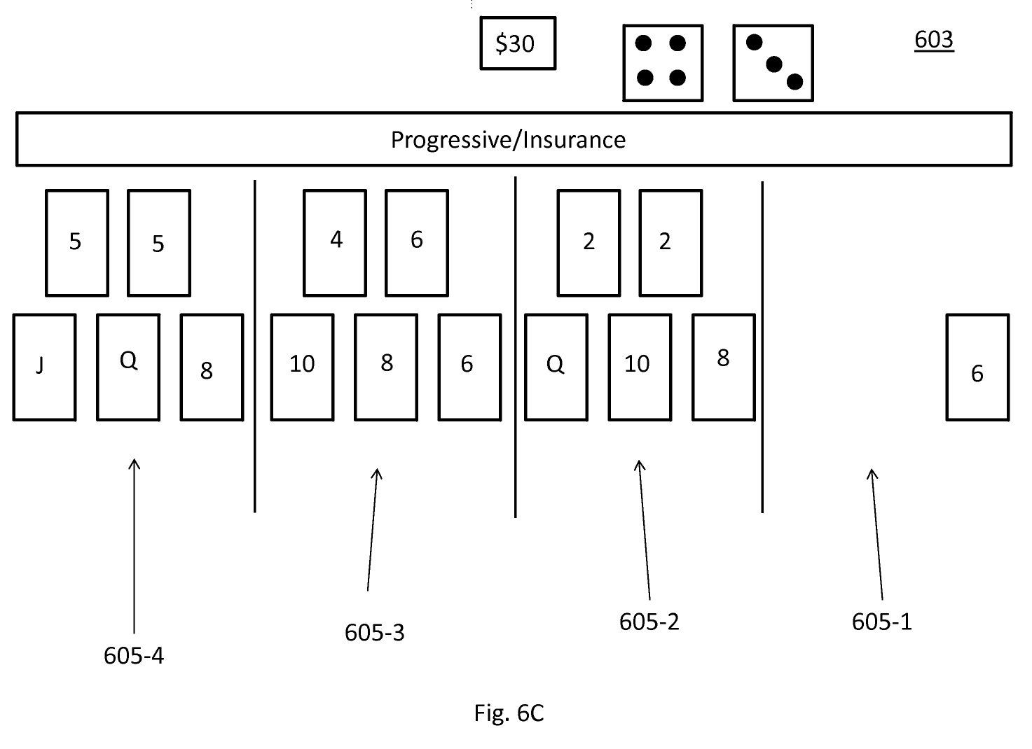

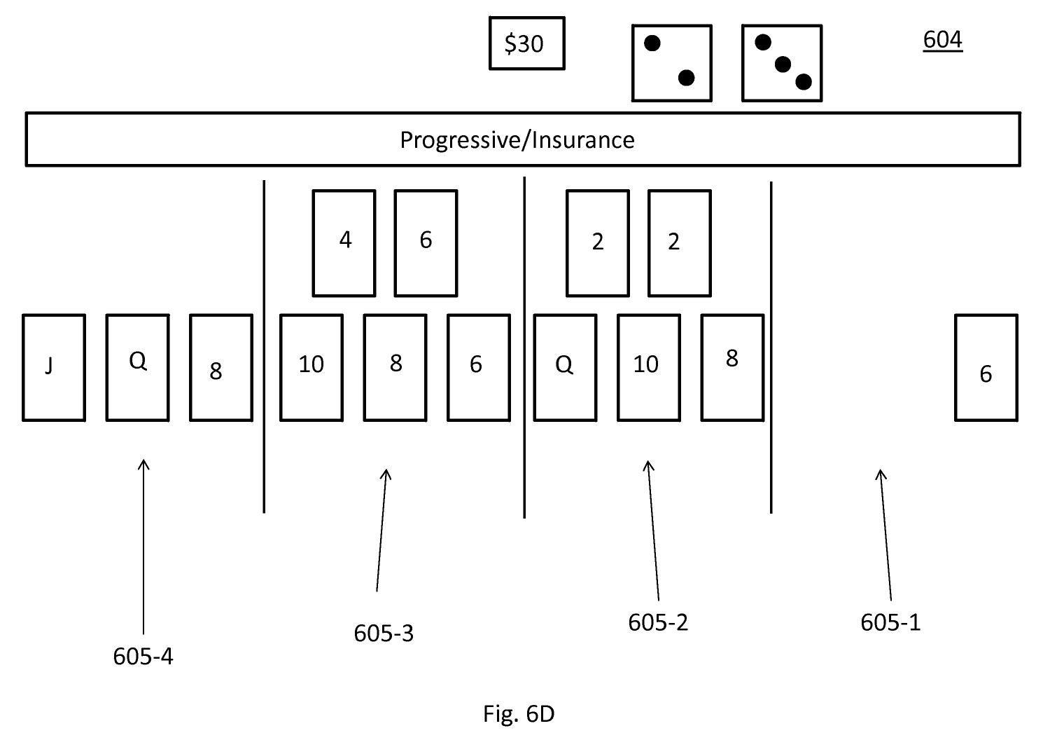

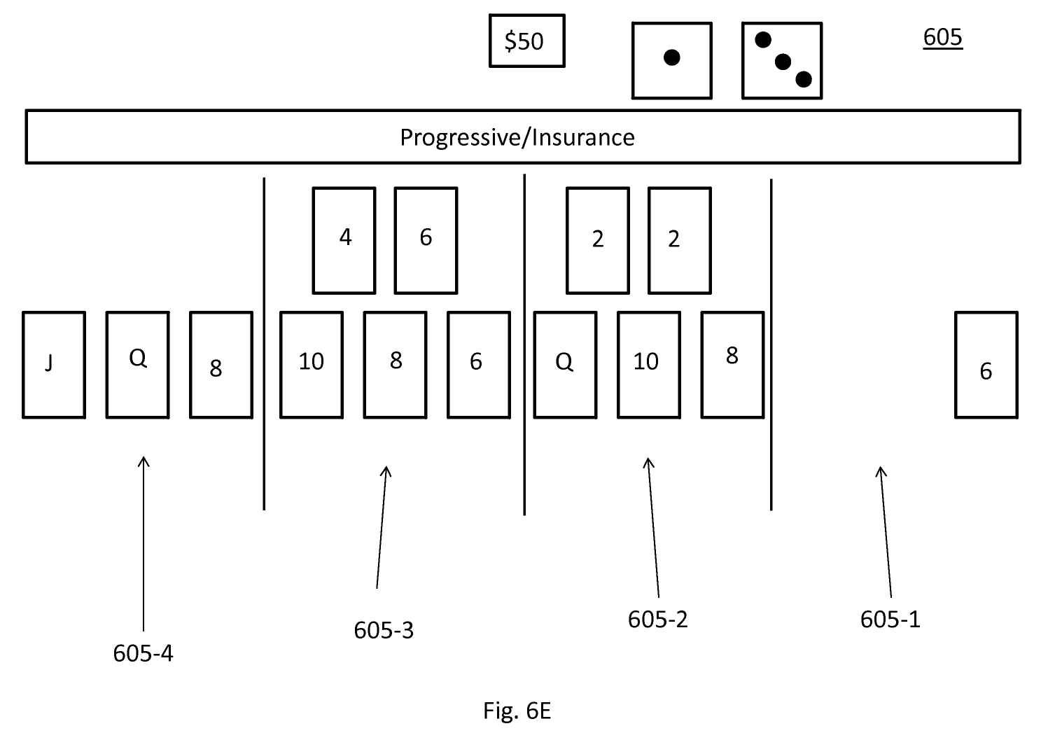

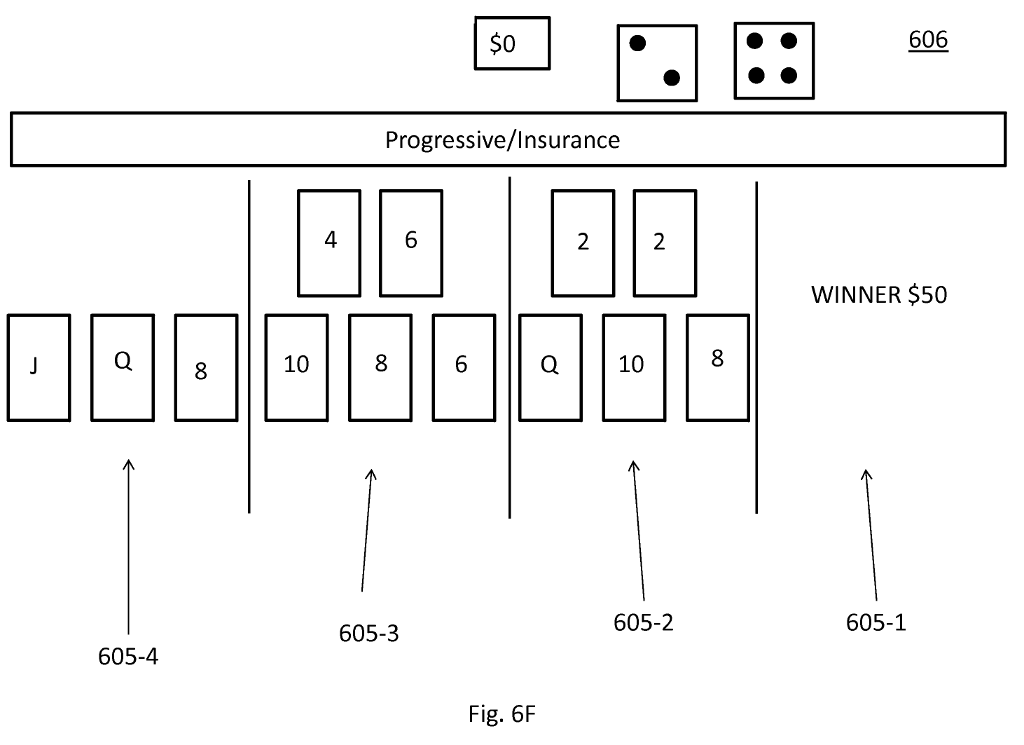

FIGS. 6a-6f show a round or hand of the casino game being played according to the embodiments of the present invention. As shown, screen shot 601 depicts a layout supporting four hands 605-1 through 605-4 although seven hands can be played during a game. Each player has paid an ante of $10 of which 50% was used to fund a pot of $20. In other embodiments, 100% of the ante goes to the house or bank (that is, none of the antes go into the pot). Hand one 605-1 comprises four of a kind such that player 605-1 is paid a jackpot award (e.g., B % of the progressive jackpot) assuming the player placed the progressive jackpot wager. The other three hands 605-2 through 605-4 do not involve hands warranting a jackpot payout. Screen shot 602 shows a dice roll of 4-5 for a sum of 9 and the four 9s of designated player shooter 605-1 are removed as shown. Screen shot 603 shows a roll of 4-3 for a sum of 7 requiring the designated player shooter 605-2 to pay a fine of $10 added to the pot (now $30). Screen shot 604 shows a dice roll of 2-3 for a sum of 5. Since the designated player shooter 605-3 has no card rank of 5, the two 5s held by neighboring player 605-4 are removed as shown. Screen shot 605 shows that player 605-1 has placed the insurance bet ($10 into pot) since player 605-1 has only a single card and designated player shooter has caused a dice roll of 1-3 for a sum of 4. In this instance, the designated player shooter has no 4s and nor does neighboring player 605-1 such that designated player shooter 605-4 pays a fine of $10 into the pot (now $50). In one embodiment, the insurance bet remains active for the remainder of the hand. In another embodiment, the insurance bet is collected by the house or paid into the pot. Screen shot 606 shows that designated player shooter 605-1 has rolled a 4-2 for a sum of 6 such that designated player shooter 605-1 removes a final card thereby winning the pot.

FIGS. 7a and 7b show a gaming table 700 suitable to conduct a game according to the embodiments of the present invention. The table 700 includes a layout 705, player positions 710 and a dice rolling area 715 defined by a wall 720 proximate the dealer station. In one embodiment, the wall 720 is transparent and approximately 4 inches tall. The wall 720 may be anchored to the table 700 using conventional means such as screws, rivets and similar fasteners or may be set into a slotted recess in the table 700 or using any other suitable means.

While the detailed description herein focuses on dice passing to the left and neighboring players being to the left, it will be apparent to those skilled in the art that the dice may pass to the right and skip players and the neighboring player may be to the right of the designated player shooter and not directly adjacent thereto.

Although the invention has been described in detail with reference to several embodiments, additional variations and modifications exist within the scope and spirit of the invention as described and defined in the following claims.

We claim:

1. An electronically-implemented method conducted over a network of gaming devices, comprising:
utilizing at least a processor, random number generator and memory to facilitate:
randomizing one or more decks of simulated playing cards, each of said one or more decks of simulated playing cards having 40 cards comprising ranks of 2-6, 8-10, Jack and Queen of spades, clubs, hearts and diamonds;
accepting, via a gaming device interface associated with each gaming device, an ante from each participating player;
displaying on a gaming device display associated with each gaming device multiple face-up cards for each player;
responsive to an input, via a gaming device interface, by a designated player shooter, generating a random dice roll of a pair of simulated dice;
comparing a sum of said random dice roll of said pair of simulated dice to ranks of each of said designated player shooter's multiple face-up cards;
based on said comparison: (i) removing one or more cards of said designated player shooter having ranks matching said sum of said random dice roll of said pair of simulated dice or (ii) if said designated player shooter holds no cards with a rank matching said sum of said random dice roll of said pair of simulated dice, comparing said sum of said random dice roll of said pair of simulated dice to ranks of each of multiple face-up cards held by a neighboring player and removing any cards having matching ranks;
collecting payment of a fine and paying said fine into a pot from said designated player shooter if neither said designated player shooter or neighboring player holds at least one card having a matching rank of said sum of said random dice roll of said pair of simulated dice; and
responsive to a designated player shooter having each of said multiple face-up cards removed, paying said designated player shooter at least a portion of said pot.

2. The electronically-implemented method of claim 1 further comprising offering an insurance bet to a neighboring player holding a single card prior to a designated player shooter rolling the dice, said insurance bet deemed a winning bet responsive to (i) said designated player shooter having no cards with ranks matching a sum of said dice roll and (ii) said single card of said neighboring player matching said sum of said dice roll.

3. The electronically-implemented method of claim 2 further comprising paying the neighboring player 50% of the pot responsive to a winning insurance bet and using the remaining 50% of the pot for a next game.

4. The electronically-implemented method of claim 1 further comprising requiring said designated player shooter to pay a fine into said pot responsive to a dice roll of 7.

5. The electronically-implemented method of claim 1 further comprising permitting said designated player shooter to roll again responsive to a dice roll of 2 or 12.

6. The electronically-implemented method of claim 1 further comprising displaying on a gaming device display associated with each gaming device five face-up cards for each player.

7. A method of conducting a casino game comprising:
shuffling one or more decks of playing cards, each of said one or more decks of playing cards having 40 cards comprising ranks of 2-6, 8-10, Jack and Queen of spades, clubs, hearts and diamonds;
accepting an ante from each participating player;
dealing to each player five face-up cards thereby generating 658,008 possible hand outcomes for each player;
designating a player shooter to roll of a pair of simulated dice in a dice roll area on a gaming table;
comparing a sum of said dice roll to ranks of each of said designated player shooter's five face-up cards;
based on said comparison: (i) removing one or more cards of said designated player shooter having ranks matching said sum of said dice roll or (ii) if said designated player shooter holds no cards with a rank matching said sum of said dice roll, comparing said sum of said dice roll to ranks of each of five face-up cards held by a neighboring player and removing any cards having matching ranks;
collecting payment of a fine and paying said fine into a pot from said designated player shooter if neither said designated player shooter or neighboring player holds at least one card having a matching rank of said sum of said dice roll; and
responsive to a designated player shooter having each of said five face-up cards removed, paying said designated player shooter at least a portion of said pot.

8. The method of claim 7 further comprising offering an insurance bet to a neighboring player holding a single card prior to a designated player shooter rolling the dice, said insurance bet deemed a winning bet responsive to (i) said designated player shooter having no cards with ranks matching a sum of said dice roll and (ii) said single card of said neighboring player matching said sum of said dice roll.

9. The method of claim 8 further comprising paying the neighboring player 50% of the pot responsive to a winning insurance bet and using the remaining 50% of the pot for a next game.

10. The method of claim 7 further comprising requiring said designated player shooter to pay a fine into said pot responsive to a dice roll of 7.

11. The method of claim 7 further comprising permitting said designated player shooter to roll again responsive to a dice roll of 2 or 12.

12. A gaming system, comprising:
a central server having at least a processor, random number generator and memory, said central server in communication with multiple gaming devices, said central server running a game application configured to:
randomize one or more decks of simulated playing cards, each of said one or more decks of simulated playing cards having 40 cards comprising ranks of 2-6, 8-10, Jack and Queen of spades, clubs, hearts and diamonds;
accept, via a gaming device interface associated with each gaming device, an ante from each participating player;
display on a gaming device display associated with each of said multiple gaming devices multiple face-up cards for each player;
responsive to an input, via a gaming device interface, by a designated player shooter, generate a random dice roll of a pair of simulated dice;
compare a sum of said random dice roll of said pair of simulated dice to ranks of each of said designated player shooter's multiple face-up cards;
based on said comparison: (i) remove one or more cards of said designated player shooter having ranks matching said sum of said random dice roll of said pair of simulated dice or (ii) if said designated player shooter holds no cards with a rank matching said sum of said random dice roll of said pair of simulated dice, compare said sum of said random dice roll of said pair of simulated dice to ranks of each of multiple face-up cards held by a neighboring player and remove any cards having matching ranks;
collect payment of a fine and pay said fine into a pot from said designated player shooter if neither said designated player shooter or neighboring player holds at least one card having a matching rank of said sum of said random dice roll of said pair of simulated dice; and
responsive to a designated player shooter having each of said multiple face-up cards removed, pay said designated player shooter at least a portion of said pot.

13. The gaming system of claim 12 wherein said central server is further running a game application configured to: offer an insurance bet to a neighboring player holding a single card prior to a designated player shooter rolling the dice, said insurance bet deemed a winning bet responsive to (i) said designated player shooter having no cards with ranks matching a sum of said dice roll and (ii) said single card of said neighboring player matching said sum of said dice roll.

14. The gaming system of claim 13 wherein said central server is further running a game application configured to: pay the neighboring player 50% of the pot responsive to a winning insurance bet and using the remaining 50% of the pot for a next game.

15. The gaming system of claim 12 wherein said central server is further running a game application configured to: require said designated player shooter to pay a fine into said pot responsive to a dice roll of 7.

16. The gaming system of claim 12 wherein said central server is further running a game application configured to: permit said designated player shooter to roll again responsive to a dice roll of 2 or 12.

17. The gaming system of claim 12 wherein said central server is further running a game application configured to: display on a gaming device display associated with each gaming device five face-up cards for each player.

18. A gaming system, comprising:
a gaming table dimensioned to accommodate at least seven players and a dealer;
a layout affixed to said gaming table;
a chip rack integrated into said gaming table; and
one or more decks of playing cards, each of said one or more decks of playing cards having 40 cards comprising ranks of 2-6, 8-10, Jack and Queen of spades, clubs, hearts and diamonds;
a pair of dice; and
a dice rolling area defined by a wall proximate a dealer area.

19. The gaming system of claim 18 further comprising a card shuffler.

20. The gaming system of claim 18 wherein said wall is transparent and approximately 4 inches tall.
